(19) United States
(12) Patent Application Publication
(10) Pub. No.: US 2001/0036258 A1
(43) Pub. Date: Nov. 1, 2001

(54) Telecommunication service for prioritizing and enhancing privacy of incoming calls

(76) Inventor: Binay Sugla, Aberdeen, NJ (US)

Correspondence Address: Ward & Olivo, Suite 300, 382 Springfield Avenue, Summit, NJ, 07901, US

(21) Appl. No.: 09/780,629

(22) Filed: Feb. 9, 2001

Related U.S. Application Data
(60) Provisional application No. 60/208,709, filed on Jun. 1, 2000.

(51) Int. Cl. H04M 3/42

(52) U.S. Cl. 379/211.01; 379/201.01

(57) ABSTRACT

A system for allowing a telephone subscriber to effectively monitor and select incoming telephone calls wherein a single actual telephone number and incoming telephone line comprises a plurality of virtual telephone numbers. A telephone subscriber may efficiently block or screen incoming calls in a courteous manner without preventing the receipt of any desired incoming call or emergency telephone call. In addition, the telephone subscriber may screen incoming telephone calls without setting up a comprehensive and labor intensive database system. The telephone subscriber is required to offer different groups of individuals several different virtual telephone numbers representing various incoming caller restrictions which are linked to a single incoming telephone line thereby effectively screening incoming telephone calls without any user-intervention.

### CROSS REFERENCE TO RELATED APPLICATIONS

This application is claiming the benefit of priority of the early filing of Provisional Application Ser. No. 60/208,709 filed Jun. 1, 2000.

### FIELD OF THE INVENTION

The present invention relates generally to a telecommunication prioritization service for use with a user's telephone system. Specifically, the invention relates to a service which utilizes a single phone line to generate a plurality of virtual numbers which allow the user to set predetermined attributes to effectively and automatically screen all incoming calls without any user intervention.

### BACKGROUND OF THE INVENTION

Although many people have become dependant on the telephone, a major complaint regarding the telephone is the seemingly endless barrage of unwanted telephone calls at all times. Annoying telephone calls have become a common everyday occurrence. Salespeople, solicitors and others often call at inconvenient times, such as the dinner hour, late evening or night, when it is more likely that a telephone subscriber will be at home. Most people would prefer to not receive such calls. However, many telephone subscribers reluctantly answer the telephone at these inopportune times due to the possibility that the incoming telephone call may be an emergency call or an important incoming telephone call. Several inventions have been developed to eliminate these everyday annoyances. However, many of these inventions have not been as effective as most people would desire. Therefore, there exists a need to implement a system to provide all telephone subscribers greater control over their telephone service which is easy to use, economically priced and provides courteous handling of incoming telephone calls which requires limited user interaction.

Telephone companies offer several services in an attempt to rectify this problem facing the telephone subscriber. To reduce the number of unsolicited telephone calls, many people have requested unlisted telephone numbers from the telephone companies. In this system, a subscriber's telephone number is distributed to a limited number of parties, thereby concealing a subscriber's telephone number from unwanted incoming telephone calls. Thus, providing the telephone subscriber a higher degree of certainty that the telephone subscriber should direct attention to the incoming telephone call. However, use of this service often results in increased costs to the telephone subscriber, while not being effective in preventing the reception of unwanted and annoying telephone calls. Salespeople and solicitors often discover the telephone number of an unlisted subscriber through various electronic devices including automatic sequential dialing machines and computer driven programs. If the secrecy of the subscriber's telephone number is breached, they must then re-distribute their telephone number to all of the individuals and institutions they desire. Furthermore, if the unlisted telephone number is utilized for any commercial transactions by the telephone subscriber then the potential for distribution increases and the purpose of having an unlisted telephone number may be defeated.

Another service which telephone companies offer the telephone subscriber is a caller identification system. Such systems allow the telephone subscriber to view the incoming caller's telephone number as it rings through to the telephone subscriber's phone set. Thus, the caller, upon viewing the incoming caller's telephone number, has the option to either answer the incoming telephone call or reject the incoming telephone call without answering the telephone or speaking to the caller. However, these identification systems have several disadvantages. First, the caller identification system requires the subscriber to view the incoming caller information and rely on the system for its accuracy. The telephone subscriber must also have the knowledge to properly identify the incoming telephone number of the calling party or risk losing what could be a potentially important telephone call. In addition, some “out-of-range” telephone calls, telephone calls from internal networks or telephone calls from pay phones are not properly identified by these identification systems. Furthermore, callers may “block out” their telephone number wherein the telephone subscriber will not be given an opportunity to identify the incoming number. These setbacks render the use of the caller identification system extremely inefficient, impractical and often useless providing the telephone subscriber with no additional means of privacy.

In addition, telephone companies have developed intricate telecommunication services in order to enhance call routing. The present invention is fully compatible with these systems and advantageously utilizes these systems (but does not require these systems to operate effectively). The basic service provided by a PSTN (Public Switched Telephone Network) is the interconnection of two telephones (that is, setting up a bearer channel between the telephones) according to a called-party telephone number input at the calling-party telephone. In particular, customer premises equipment (CPE) (i.e., standard analogue telephones) are connected to switching points through an access network. In conventional telephony systems, there are computerized service control points (SCPs) that provide central routing intelligence (hence intelligent network) and Dialed Number Identification Service (DNIS), whose purpose is to control the routing of incoming telephone calls.

One problem that frequently occurs in PSTN operations utilizing a DNIS system is the problem of mis-routed telephone calls (i.e., calls that arrive at one agent's station, and the agent, in interacting with the caller realizes that the agent is not the right person to help the caller). This mis-routing problem can occur in several ways. There may be some hardware or software failure, for example, resulting in a call being routed to a different agent than intended. It may be possible as well, that a caller had provided incorrect information to an initial-processing system, for any of a number of reasons, and the call was mis-routed as a result. An even more common reason for mis-routed calls is load balancing that may be done in the network in order to handle all of the incoming telephone calls.

A PSTN operation utilizing a DNIS system is fully compatible with the present invention; however, a PSTN operation by itself is not able to achieve the high level of privacy or efficiency disclosed in the present invention. For example, it is common in present systems for a telephone subscriber to request three separate telephone lines. Each line can be individually connected to a CPE (Customer Premises Equipment) to route incoming telephone calls. Subsequently the incoming call can be received by a standard analogue telephone which perceivably could be connected to a TOD (Time of Day clock). The TOD would then actuate a ringer depending on the DNIS information transmitted over the telephone line. However, such a system requires the telephone subscriber to order and pay for several telephone lines to achieve the desired privacy. In addition, this system requires the telephone subscriber to utilize intricate and often expensive CPE.

Another system, which is fully compatible with the present invention, utilizes similar technology wherein the three separate incoming telephone lines are connected to three separate CPEs to route the incoming telephone call. Subsequently the incoming telephone call can be received by a standard analogue telephone which perceivably could be connected to a TOD. The TOD would then actuate a ringer depending on the DNIS information transmitted over the telephone line. However, this system exhibits the same deficiencies as the above system, because the telephone subscriber must still request several telephone lines and must still utilize intricate and often expensive CPE. Furthermore, in this system the telephone subscriber must purchase multiple CPEs in order to implement the system.

Another alternative for telephone subscribers is to use an answering machine, typically with a recorder and a speaker system. The telephone subscriber may listen to an incoming caller leaving a message in an attempt to determine the importance of the incoming call. Most answering machines allow the telephone subscriber to hear the voice of the caller. The subscriber can then selectively pick up the receiver and talk to the caller once the caller has been identified. However, this approach does not provide the telephone subscriber with any additional privacy or protection against incoming telephone calls at inopportune times. For example, all incoming telephone calls, including unwanted telephone calls, will ring the telephone subscriber's telephone and interrupt the telephone subscriber. In addition, the telephone subscriber must still manually screen the call by traveling to the telephone answering machine and listening to the caller's voice to determine whether or not to accept the incoming telephone call. Furthermore, the incoming caller, upon hearing the answering machine recording, may believe that the subscriber is not home and may terminate the call, eliminating the opportunity for the telephone subscriber to retrieve a potentially important incoming telephone call. A telephone subscriber may also miss an important telephone call if a known caller calls from an unknown telephone number which the telephone subscriber does not recognize. Finally, such a system does not distinguish between an emergency telephone call and an ordinary telephone call allowing the telephone subscriber to inadvertently screen an emergency incoming telephone call.

A final solution to end these unwanted telephone calls is to not answer the telephone or place the telephone “off the hook.” This solution does not provide the desired privacy and may present difficulties for the telephone service provider. For example, by placing the receiver “off the hook,” the telephone subscriber cannot receive any incoming telephone calls, thereby blocking emergency calls. In addition, an “off the hook” telephone generates an irritating buzzing sound, usually followed by a recorded announcement. This sound and announcement is generated by the telephone service provider to deter the telephone subscriber from leaving the telephone “off the hook” as this would tend to unnecessarily tie up the telephone switching equipment. For this reason, a receiver which is “off the hook” may be temporarily disconnected from the switching board of the telephone system after the receiver has been “off the hook” for a predetermined period of time. Furthermore, in some instances, the receiver may not be reconnected immediately after being placed “on the hook,” making the telephone unavailable to the subscriber for a period of time after being placed back “on the hook.” Since calls could not be processed at these times, a potentially disastrous situation could arise in an emergency.

Several inventions have been developed attempting to end unwanted incoming telephone calls. Lutz U.S. Pat. No. 4,845,743 discloses a telephone routing method wherein a caller is required to input a code to be given access to complete a telephone call to a particular number. Lutz teaches a tone decoder that is responsive to incoming tone pulse calls which outputs a binary code corresponding to the frequency of the incoming tone pulse. Thus, a caller must input one or more code numbers after dialing the receiving party's telephone number whereupon the code numbers are compared with the receiving party's predetermined list of acceptable code numbers. If the code numbers associated with the incoming call represent a successful code match the call is then routed in accordance with the telephone subscriber's predetermined settings. However, Lutz requires the calling party to input codes for authorization to complete every telephone call. Therefore, this system results in the inability for certain callers to contact the telephone subscriber if a code cannot be successfully entered. Such a system limits many desired incoming telephone calls in addition to limiting any emergency telephone calls if the incoming caller does not have knowledge of the desired code. Furthermore, such a system may be easily defeated if the special access code is compromised.

Rose U.S. Pat. No. 4,850,013 and Small U.S. Pat. No. 5,563,935 disclose call screening systems which require a caller to enter a preselected code of one or more digits along with the called telephone number. If the calling party fails to enter the pre-selected code the telephone receiver is not activated. When the telephone circuit receives the call the calling party is required to enter the frequency code or an encoded signal by pressing the pre-selected code into the touch tone keypad. In the event that the entered code matches the pre-selected code, the circuit directs the incoming telephone call to the telephone and activates the ring through. If however, a code is not entered or the entered code does not match the pre-selected code the circuit electrically disconnects the telephone or directs the incoming telephone call to the telephone answering machine.

Both of these inventions fail to disclose an effective mechanism for the telephone subscriber to set-predetermined calling characteristics such as time restrictions on certain incoming calls. In addition, these inventions require the telephone subscriber to disclose their pre-selected code to any individual seeking to contact the subscriber. Therefore, once the telephone subscriber discloses the pre-selected code for any commercial transaction the telephone subscriber may no longer receive the desired privacy. In addition, while this may prevent several unwanted calls, it would also prevent many desirable calls.

O'Brien U.S. Pat. No. 4,893,329 discloses a telephone call deferral system which allows incoming telephone calls to be deferred for a user selected period or until a user selected time. During the defer time, incoming telephone calls are intercepted and the incoming caller receives a voice message indicating that the incoming telephone calls are not currently being received but will be taken at the specified defer time. Programming of the defer mode is effected from the key pad of any telephone instrument connected to the telephone line of the user. An override system allows emergency telephone calls to be completed from parties in possession of a special access code. However, such a system may be easily defeated if the special access code is compromised. For example, if a special access code is provided to emergency personnel (Police, Fire Department, Hospital, or the like), it is foreseeable that the access code may eventually be disclosed to unauthorized users. In addition, this system provides only for emergency caller access. Therefore, a telephone subscriber cannot selectively screen telephone calls to receive calls from desired individuals.

Morganstein U.S. Pat. No. 5,029,196 discloses a method for facilitating call completions utilizing a call identification telephone number which is transmitted along with an incoming call. This user programmable telecommunications system for a private branch exchange (PBX) allows a called party to pre-program alternate destinations for incoming calls within the PBX. Incoming calls are identified by the incoming caller's telephone number and may be selectively routed to a voice store and forward facility allowing for the calling party to leave a message. The telephone subscriber/user-programmer can designate one or more of a list of incoming telephone numbers as “important,” “intermediate” or “other.” Incoming calls from these numbers will be directly routed by the system to the user. Although this system does provide some additional privacy for the telephone subscriber, this system has several disadvantages. First, the system only allows users from specified calling numbers to have full access to the telephone subscriber. If an incoming call by a known caller is made from a different number, the known incoming telephone call will not be received regardless of whether the telephone subscriber wishes to receive the call. Furthermore, other unwanted incoming telephone calls from the same number will have full access to the telephone subscriber. In addition, this system only provides for general business applications and does not extend to private residential use. For example, the disclosure provides for rerouting of telephone calls to a “secretary, switchboard attendant or colleague” who presumably could determine whether a call was emergency in nature or from a desired caller. Therefore, such a system is not readily adaptable for home use, as most individuals do not have such personnel to manually monitor their incoming calls. Another disadvantage of this system is that it is very difficult to program, especially for the average subscriber. To designate a number as “important” or “intermediate,” the subscriber must first program the incoming caller's number manually and assign that number a destination. In addition, it is difficult for a subscriber to alter the classification of individual incoming telephone numbers for short periods of time.

Brown U.S. Pat. No. 5,060,255 discloses a timed-do-not-disturb service, wherein a system processor compares a subscriber identification with stored class of service information to recognize that timed-do-not-disturb service is to be provided to an identified subscriber station. The processor determines the identity of the subscriber station which is to receive the requested service and the time of the service, generates a programming signal and formats the signal for compatibility with the switch to which the station is connected. However, Brown fails to allow for emergency telephone calls or selected telephone calls to be passed through. Further, the disclosed call screen system only allows for the blocking of telephone calls for a predetermined period of time. This system does not provide for effective perpetual telephone call screening and categorizing. Furthermore, this invention predetermines whether the telephone subscriber wishes to receive an incoming telephone call instead of offering effective alternatives of either re-routing the incoming telephone call to another location such as a telephone answering service or machine.

Carlson, et al. U.S. Pat. No. 5,408,528 discloses a telephone routing service. Specifically, an incoming telephone call is routed through a telephone network to a piece of terminal equipment. The terminal equipment analyzes call information associated with the incoming telephone call. The call information is divided into separate call attributes, such as calling telephone number and called telephone number. One or more number lists, stored in the terminal equipment, are then searched to determine whether they contain an entry that matches the call attributes. If a match is not found, the call is rejected. If a match is found, the call is routed as specified by the number list entry having the most optimal match. However, Carlson fails to describe a telecommunications service which has user-defined telephone call restrictions. This invention analyzes the incoming call based on the incoming telephone call's attributes as defined by the terminal equipment or the incoming caller. This system is susceptible to the same disadvantages as previously described in that it does not make concessions for the “emergency” call and may reject many other wanted calls.

Redd, Jr. et al. U.S. Pat. No. 5,467,388 discloses a system for allowing a telephone subscriber to selectively block incoming telephone calls for selected time periods or during programmed time intervals. The subscriber may pre-program a time interval in minutes, or a time period (start time and end time) for which some or all incoming telephone calls are to be blocked. The subscriber may assign caller numbers, or personal identification numbers to one of a plurality of tiers of access. In addition, the subscriber may assign a special tier allowing for emergency telephone calls. However, the system disclosed in Redd can be easily defeated if the caller numbers or personal identification numbers are compromised. In addition, this system may prevent several unwanted calls while at the same time preventing many desirable calls.

Venier U.S. Pat. No. 5,768,358 discloses a virtual public numbering domain which coexists with an existing geographic North America telephone network numbering plan. An abbreviated virtual number, comprising 1 to 10 digits, may be dialed to access a unique dialing plan from any telephone station in a particular network. Upon dialing a virtual telephone number, the incoming caller may select one of a number of telephone devices associated with the single virtual telephone number. Additionally, routing means are disclosed which allow for the compatibility of virtual public numbers with standard phone numbers in a network whereupon a number is recognized as either virtual public number type or standard telephone number type and is routed to an appropriate system based on the number type. Venier, however, does not disclose a virtual number service wherein a plurality of virtual phone numbers, which are of standard 10 digit telephone number format, are automatically directed to one common location allowing the incoming telephone call to be routed in accordance with the telephone subscriber's predetermined settings.

Scherer et al. U.S. Pat. No. 5,867,562 discloses a system whereby a telephone call processor examines the dialed number, the caller Automatic Number Identification (ANI) and two informational digits to route an incoming telephone call depending on previous caller settings. Scherer discloses a solution for commercial uses of call routing wherein a caller establishes an identification upon first calling a phone system through a combination of prompted questions and other caller information unique to the calling location and/or number. Incoming caller identification stored in the telephone subscriber's system is used to recall the user's customized information and reduce the number of prompted questions to determine the nature of the call when subsequent incoming telephone calls are received from previously received telephone numbers. Scherer, however, does not teach of a virtual number service wherein a telephone subscriber may receive calls comprising multiple unique phone numbers to be received at the same location. Furthermore, Scherer does not provide customized telephone call routing depending only on the called number of the caller without requiring a database with information unique to that caller. In addition, it does not disclose customized call screening which can be established by the telephone subscriber before any telephone call is received.

Robuck U.S. Pat. No. 5,991,367 discloses a telephone call screener. The screener recognizes an unwanted incoming telephone call and disconnects the user's telephone accordingly. The screener then reads prerecorded messages to the caller, attempting to verbally filter out and reject undesired call types. The screener generates a random single digit number, and requests the caller to press this number key on their phone to verify compliance with the previously read message. Depending on the caller's actions, the call is either disconnected, or is allowed to ring through to the user's telephone. However, this system fails to effectively screen unwanted telephone calls by automatically assuming that an incoming telephone call is unwanted based on a single response by a caller. This application is not a viable alternative for an individual or entity seeking to categorize the priority and importance of incoming telephone calls, nor does it provide an effective mechanism for routing desired incoming telephone calls. Furthermore, this invention fails to allow the telephone subscriber to actively participate in determining whether the telephone subscriber wishes to receive the incoming telephone call or possibly return the incoming telephone call at a later date.

In view of the foregoing, clearly there exists a need for an improved telecommunications service for prioritizing incoming telephone calls and enhancing the privacy for telephone subscribers that addresses the shortcomings of the prior art. Thus, it remains a requirement in the art to provide a usable telecommunication system for allowing a subscriber to screen out unwanted or inconvenient telephone calls, while still allowing the subscriber full access to the telephone for desired incoming calls, emergency calls, and outgoing calls.

### SUMMARY OF THE INVENTION

Many telecommunication services, including “800” number services and personalized telecommunication services, have been developed with the objective of linking several actual telephone numbers and telephone incoming lines to a single virtual telephone number which is associated with a single person, institution or entity. However, the present invention discloses the reverse objective of linking an ordinary, single actual telephone number and incoming telephone line to several virtual telephone numbers to reduce costs and increase privacy for the telephone subscriber. The present invention may be provided by either a local telephone company, a long distance telephone company or any other telephone network service provider. In addition, the present invention is compatible with all existing telecommunications networks and apparatus, including DTMF-based networks, internal modems, Internet Networks and Integrated Services Digital Networks; however, present day networks to future networks not yet contemplated, may also be used. Furthermore, the present invention is applicable for use with all types on calls including but not limited to telecommunication based calls, video calls and alternate types of voice calls. The present invention is applicable to all incoming telephone calls regardless of whether they are transmitted from a Private Branch Exchange (PBX) or utilize Dialed Number Identification Service (DNIS) or Automatic Number Identification (ANI) characteristics which many caller identification systems rely on.

There are numerous ways for an ordinary telephone subscriber to achieve an enhanced level of privacy from unwanted incoming telephone calls. One option is for a telephone subscriber, utilizing a single incoming telephone channel, to subscribe to multiple telephone numbers. An incoming telephone call and associated DNIS characteristics may be routed to the telephone subscriber through the multiple telephone numbers. The incoming telephone call may be further routed to an ordinary telephone having a TOD which can analyze the incoming telephone based on the time the call is received in an attempt to avoid unwanted telephone calls.

Another alternative for the telephone subscriber is to request more than one incoming telephone channel. Each telephone channel may then be connected to individual ordinary telephones, each having a TOD, which compares the incoming telephone call's characteristics with predetermined parameters. For example, a telephone subscriber may automatically reject incoming telephone calls on the first telephone channel between the hours of 11:00 P.M. and 6:00 A.M. and between 5:00 P.M. and 9:00 A.M. on the second incoming channel. Thus, the telephone subscriber could avoid unwanted incoming telephone calls at specified restricted time intervals.

Another alternative for the telephone subscriber is to request multiple channels connected to one ordinary telephone. The ordinary telephone, having a TOD, can analyze the incoming telephone as compared to the channel it was received on and allow the call to ring-through or be rejected.

However, the most efficient method for a telephone subscriber to enhance incoming call privacy is disclosed herein. In the present invention, a telephone subscriber with an ordinary, single actual telephone number and telephone line may be entitled to request several virtual telephone numbers linked to the ordinary, single telephone line and telephone number. The telephone subscriber may further specify a set of attributes or restrictions (i.e. time-of-day restrictions, call type restrictions, incoming call area code restrictions, DNIS characteristics restrictions, ANI restrictions or other like restrictions) for each of the virtual telephone numbers provided by the local telephone company, the long distance telephone carrier or other telephone network service provider. If however, the telephone subscriber fails to set specified restrictions, then all incoming telephone calls will be directed to the ordinary telephone number. To illustrate this concept the following example of the preferred embodiment is offered.

A telephone subscriber has a single incoming telephone line designated as (XXX) XXX-XXX0 (wherein “X” denotes an single digit number). However, to ensure total privacy and avoid unwanted incoming telephone calls, the telephone subscriber needs to provide four different telephone numbers to four different groups of people. Therefore, under the presently available options the telephone subscriber would be required to request four different telephone numbers from the local telephone service subjecting the telephone subscriber to increased monthly telephone costs as well as installation charges for the additional three incoming telephone lines. The present invention provides the telephone subscriber with the alternative of subscribing to the Virtual Number Service disclosed herein. This Virtual Number Service is available to the telephone subscriber at a notably lower monthly cost, or possibly no cost, and does not require any installation service or installation cost.

In the present example the telephone subscriber wishes to provide different telephone numbers to the different groups of individuals, institutions or entities. For example, the first group (“Group A”) is exemplified by the telephone subscriber's children's school or daycare. The second group (“Group B”) refers to the people at credit card institutions, personal banks, and other businesses with whom the telephone subscriber wishes to receive incoming telephone calls from. The third group (“Group C”) are defined as the telephone subscriber's personal friends and family. Finally, the fourth group (“Group D”) refers to groups of individuals, businesses or entities with whom the telephone subscriber wishes to not speak with directly but wishes to receive only a message from so that the telephone subscriber may later return the call at the telephone subscriber's convenience.

Under the present invention, the telephone subscriber may request four different numbers for the four groups described herein. For example, virtual telephone number (XXX) XXX-XXX1 could be maintained for Group A, virtual telephone number (XXX) XXX-XXX2 could be maintained for Group B, virtual telephone number (XXX) XXX-XXX3 could be maintained for Group C and virtual number (XXX) XXX-XXX4 could be maintained for Group D. Although four different virtual telephone numbers are provided, all incoming telephone calls to any of the four virtual telephone numbers will operate through the original and “real” phone number and telephone line designated as (XXX) XXX-XXX0.

In order to ensure privacy and avoid unwanted telephone calls, the telephone subscriber can specify restrictions for the treatment of incoming telephone calls received by each of the specific virtual numbers in addition to the ordinary incoming telephone number. For example, for Group A, the telephone subscriber may specify that calls to (XXX) XXX-XXX1 will only result in a ring at (XXX) XXX-XXX0 during the time the children are in school or in a daycare (i.e., 8:30 A.M. to 3:30 P.M.). In addition, calls to (XXX) XXX-XXX1 may be rerouted to another number where the telephone subscriber can be found. For Group B, the telephone subscriber may specify that all incoming calls to (XXX) XXX-XXX2 will only result in a ring at (XXX) XXX-XXX0 during “normal business hours” (i.e., 8:00 A.M. and 5:00 P.M.). In addition, as a courtesy, the Virtual Number Service may provide a message to the credit card institutions, personal banks, and other businesses informing them of the time restriction and asking them to call back during normal business hours. For group C, the telephone subscriber may block calls made to (XXX) XXX-XXX3 during nighttime hours (i.e., between 10:00 P.M. and 6:00 A.M.) and allow an answering machine or service to attend to the call and record the message. For Group D, the telephone subscriber may block the incoming calls entirely or bridge the incoming call to another party, since this is the group with whom the telephone subscriber wishes to not speak with directly but wishes to receive only a message through an answering machine or service in order to return the call at the telephone subscriber's convenience.

A novel aspect of this invention is that the telephone subscriber can achieve a higher degree of control over all incoming telephone calls then would have been possible using any of the existing telecommunications services. By classifying the incoming telephone calls, and distributing the virtual telephone number accordingly, the telephone subscriber can establish priority, privacy and convenience for all incoming telephone calls without the possibility of “missing” any important or emergency telephone calls.

In addition, this invention overcomes the deficiency of the prior art in that once a business, salesperson or solicitor discovers a telephone number and commences unwanted telephone calls to the telephone subscriber, the telephone subscriber may simply change the call restrictions to that specific telephone number. In addition, it would be easier to delete, add or change a virtual phone number without incurring substantial costs thereby allowing the telephone subscriber to regain privacy quickly if a particular virtual telephone number is compromised.

Therefore, it is an object of the present invention to provide an enhanced mechanism for handling incoming telephone calls which overcomes the aforementioned disadvantages with the main objective of eliminating unwanted incoming telephone calls, while still allowing desired incoming telephone calls

It is a further object of the present invention to provide an automated mechanism for effectively and efficiently screening unwanted telephone calls while allowing for the “emergency” incoming call to still be received by the telephone subscriber.

Furthermore, it is another object of the present invention to provide a flexible system for routing an incoming telephone call to an optimal destination.

Further, it is an object of the present invention to automatically screen every incoming telephone call without having any user involvement such as pressing buttons, using pre-established codes or keys, having to enter data into telephone lists, or requiring the telephone subscriber to listen to incoming calls, screen the incoming calls and ultimately decide whether or not to reject or accept the incoming telephone call.

It is still a further object of the present invention to screen unwanted incoming telephone calls without requiring the telephone subscriber to enter “approved,” “accept,” “allowable,” or like commands into a user database.

In addition, it is an object of the present invention to screen incoming telephone calls without the use of Caller Identification services and equipment and the associated drawbacks of such systems.

Other objects, features and characteristics of the present invention, as well as the methods of operation and functions of the related elements of the invention, and the combination of parts and economies of development and performance, will become more apparent upon consideration of the following detailed descriptions with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a flowchart summarily depicting the attributes of the invention;

FIG. 2 is a flowchart depicting the technical structure of the invention and the processing apparatus utilized to achieve the desired prioritizing while enhancing privacy for a telephone subscriber;

FIG. 3 depicts one embodiment of the present invention within the existing telephony network;

FIG. 4 is a diagram depicting an example of an attribute table for a single incoming virtual phone number based on a telephone subscriber's specification;

FIG. 5 is an alternative embodiment of the Virtual Number Service disclosed herein utilizing a computer-based offsite network;

FIG. 6 is an alternative embodiment of the Virtual Number Service disclosed herein utilizing an Internet-based call network.

### DETAILED DESCRIPTION OF THE PREFERRED EMBODIMENTS

As required, a detailed illustrative embodiment of the present invention is disclosed herein. However, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

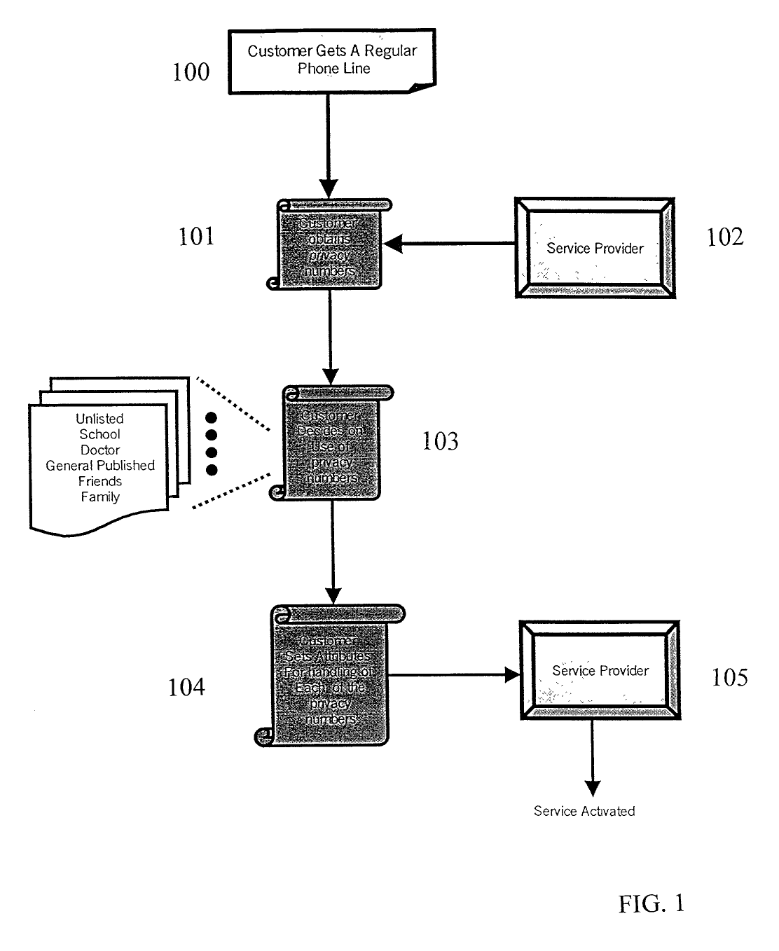

Referring first to FIG. 1, depicted is a flowchart setting forth the attributes of the invention. First, a telephone subscriber receives a single ordinary telephone line 100 into their home, business, institution or other entity. Next, the telephone subscriber requests additional virtual telephone numbers which are linked to the single ordinary incoming telephone line. Thus, the telephone subscriber is only required to install and maintain one telephone line while utilizing the benefits of several different telephone numbers (“virtual telephone numbers”). The virtual telephone numbers may be provided by either a local telephone company, a long distance telephone company or any other telephone network service provider 102. Thereafter, the telephone subscriber may select a set of attributes and restrictions 103, for the call acceptance and routing, such as “timed-do-not-disturb” restrictions, time-of-day restrictions, call type restrictions, incoming call area code restrictions, DNIS characteristics restrictions, ANI restrictions or other like restrictions, for each of the virtual telephone numbers provided by the telephone network provider. The telephone subscriber then would be required to program 104 the set of attributes and restrictions.

Programming of the attributes and restrictions may be completed by several methods. For example, in the preferred embodiment, the telephone subscriber may utilize an electronic call handling apparatus, provided by the telephone network provider at the central office, to easily and efficiently program the desired attributes. In an alternative embodiment, the telephone network provider may provide this programming service through voice or touch-tone prompts through the telephone. In another embodiment, the telephone network provider may place the processing equipment in the home of the telephone subscriber. The set of attributes and restrictions specified by the telephone subscriber allows the call handling equipment provided by the telephone network provider 105 to determine how the incoming calls to the virtual telephone numbers should be handled.

For example, the following attributes and restrictions 103 may be set by the telephone subscriber. A telephone subscriber has an incoming telephone line designated as (XXX) XXX-XXX0. The telephone subscriber will then be able to link to the Virtual Number Service. The telephone subscriber can then provide different telephone numbers to the following groups. The first group (“Group A”) is exemplified by the telephone subscriber's children's school or daycare. The second group (“Group B”) refers to the people at credit card institutions, personal banks, and other businesses with whom the telephone subscriber wishes to receive incoming telephone calls from. The third group (“Group C”) are defined as the telephone subscriber's personal friends and family. Finally, the fourth group (“Group D”) refers to groups of individuals, businesses or entities with whom the telephone subscriber wishes to not speak with directly but wishes to receive only a message from so that the telephone subscriber may later return the call at the telephone subscriber's convenience. Under the disclosed invention, the telephone subscriber may request four different numbers for the four groups defined. For example, virtual telephone number (XXX) XXX-XXX1 could be maintained for Group A, virtual telephone number (XXX) XXX-XXX2 could be maintained for Group B, virtual telephone number (XXX) XXX-XXX3 could be maintained for Group C and virtual number (XXX) XXX-XXX4 could be maintained for Group D. Although four different virtual telephone numbers are provided, all incoming telephone calls to any of the four virtual telephone numbers will operate through the original and “real” telephone number and telephone line designated as (XXX) XXX-XXX0.

In order to ensure privacy and avoid unwanted telephone calls, the telephone subscriber can specify restrictions for the treatment of incoming telephone calls received by the specific virtual numbers. For example, for Group A, the telephone subscriber may specify that calls to (XXX) XXX-XXX1 will only result in a ring at (XXX) XXX-XXX0 during the time the children are in school or in a daycare. In addition, calls to (XXX) XXX-XXX1 may be rerouted to another number where the telephone subscriber can be found. For Group B, the telephone subscriber may specify that all incoming calls to (XXX) XXX-XXX2 will only result in a ring at (XXX) XXX-XXX0 during normal business hours of eight a.m. and five p.m. In addition, as a courtesy, the Virtual Number Service may provide a message to the credit card institutions, personal banks, and other businesses informing them of the time restriction and asking them to call back during normal business hours. For group C, the telephone subscriber may block calls made to (XXX) XXX-XXX3 between ten p.m. and six a.m. and allow an answering machine or service to attend to the call and record the message. For Group D, the telephone subscriber may block the incoming calls entirely since this is the group with whom the telephone subscriber wishes to not speak with directly but wishes to receive only a message through an answering machine or service in order to return the call at the telephone subscriber's convenience. Although there exists numerous modes of treatment for any incoming calls, the telephone subscriber may program any of the unwanted incoming virtual telephone numbers or “after-hours” incoming telephone calls to constantly ring at the calling party end, provide a “busy signal” at the calling party end, route to voice mail or route to an answering machine, among other options.

Furthermore, if a virtual number is compromised or disclosed to the wrong recipient, the telephone subscriber can easily correct the error. First, the telephone subscriber may simply change the virtual number. This option is an improvement over the prior art as it does not require extensive alterations by the telephone company. Another alternative allows for the telephone subscriber to change the call restrictions associated with the compromised virtual number. An additional safeguard available to the telephone subscriber under the present invention allows the telephone subscriber to program the virtual number service to analyze the ANI characteristics of an incoming call made by a business, salesperson or solicitor along with the virtual number characteristics. Thus, when a call is received from a business, salesperson or solicitor the incoming telephone call can be treated properly. For example, if a business, salesperson or solicitor discovers that the telephone subscriber may also be reached at (XXX) XXX-XXX1, a virtual number designated only for calls relating to the telephone subscriber's children, the telephone subscriber may program the virtual number service to treat this call as though it was received on (XXX) XXX-XXX3, thereby maintaining the privacy desired. However, if a telephone subscriber wishes to receive an incoming call from a predetermined Group B calling party, outside of the call restrictions for Group B, the telephone subscriber may program the system to identify the calling party through the ANI characteristics of the party's incoming call and route the call in accordance with the telephone subscriber's request. For example, the telephone subscriber may program the virtual number service to provide a voice mail message to a desired calling party with the specified ANI characteristics informing the calling party to call a different telephone number, such as the virtual telephone number associated with Group A, where the telephone subscriber may be reached.

In an alternative embodiment of the present invention, the virtual number service analyzes and comprises the System Message Detail Recording (SMDR) data. Thus, the telephone subscriber may determine how frequently a Group C incoming call was received “after-hours,” allowing the telephone subscriber to alter the virtual telephone number characteristics.

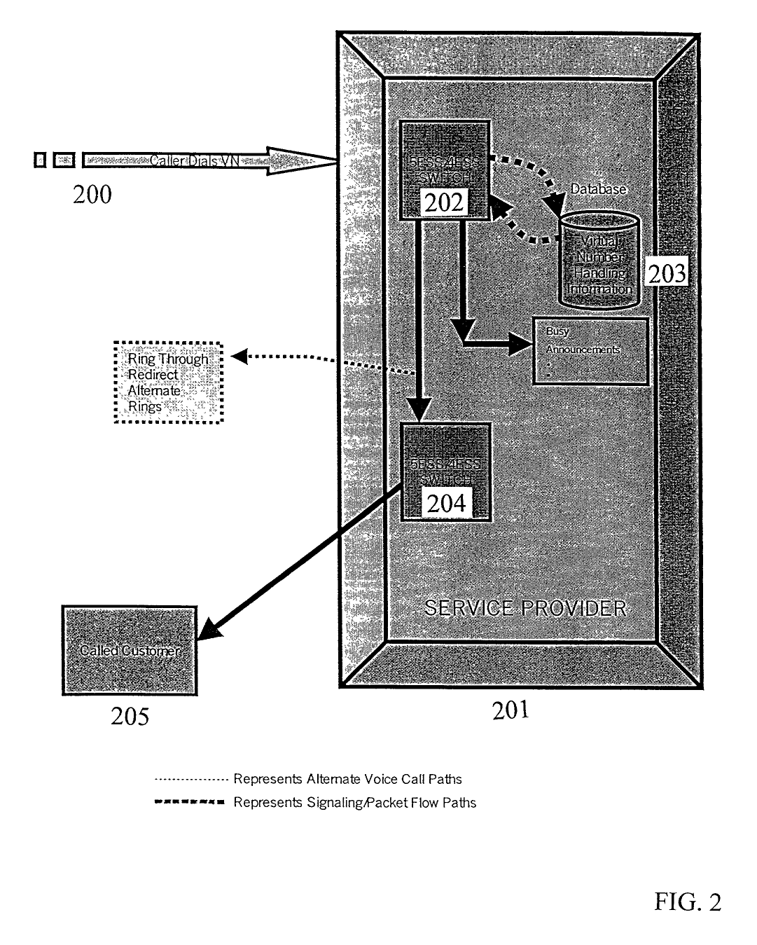

Turning next to FIG. 2, depicted is a flowchart representing a further understanding of the present invention. An incoming virtual number telephone call is initiated by a caller 200. The incoming virtual number telephone call 200 then travels to the service provider for processing 201. The call handling apparatus first transfers the incoming virtual number telephone call 200 to a first processing switch 202. The first processing switch then analyzes the telephone call characteristics. Herein the incoming virtual number telephone call 200 is examined and circulated through the virtual number handling information database 203 to determine if the telephone subscriber desires to receive the incoming virtual number telephone call. The virtual number handling information database 203 compares the incoming telephone call attributes with the virtual telephone number restrictions. If the incoming virtual number telephone call does not meet the specific criteria which was preset by the telephone subscriber the call is routed to various points of termination (i.e. busy signal, announcement, answering system or service). However, if the incoming virtual number telephone call does meet the specific criteria the incoming virtual number telephone call is routed to several points of transfer. For example, the incoming virtual number telephone call 200 may ring through, be redirected, or alternated. Alternatively, the incoming virtual number telephone call may be routed to a second processing switch 204 wherein the incoming virtual number telephone may be sent to the telephone subscriber's ordinary telephone line 205 to be received by the telephone subscriber.

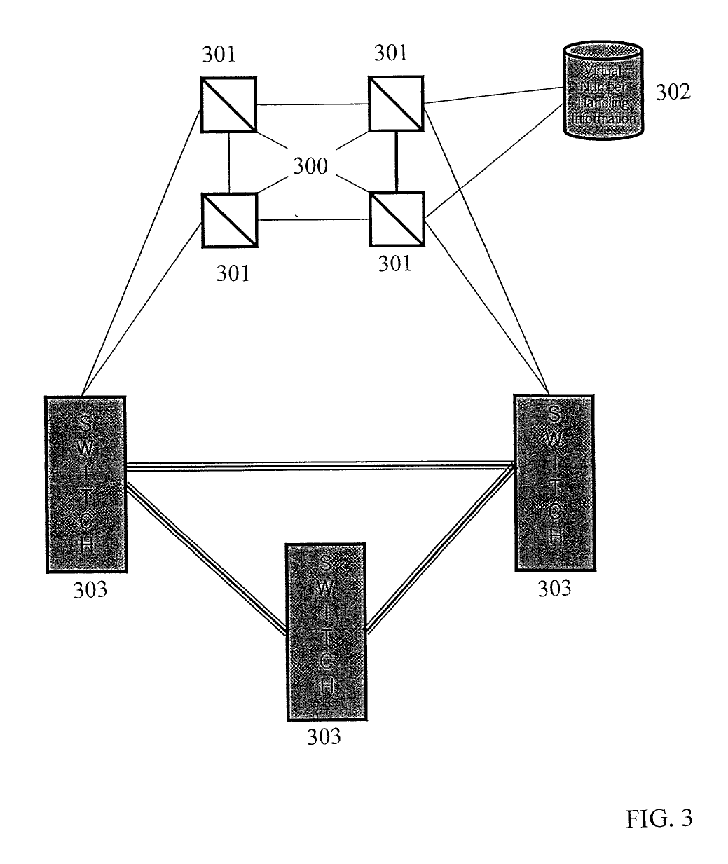

Referring next to FIG. 3, depicted is one embodiment of the virtual number system within the current telephony network. The implementation is straightforward and uses infrastructure that is already in place to support 800, local number portability, Digital Number Identification Service (DNIS) and other similar services.

Incoming calls are received by the telephony network 300. When an incoming virtual telephone number is received it is transferred within the telephony network 300 to a series of signaling transfer points 301. Within the telephony network 300 and the signaling transfer points 301, a query is sent to a service control point 302 wherein a virtual number handling information database operates. The query analyzes the attributes of the calling party including the current time. The virtual number handling information database executes the query and returns the call handling instructions to one of the signaling transfer points 301 based on the attributes specified for that incoming virtual telephone number. Thereafter, one of the signaling transfer points transfers the incoming virtual telephone number to one of a plurality of switches 303 wherein the incoming virtual telephone call is properly routed depending on the call handling instructions.

Furthermore, if a telephone subscriber wishes to change the virtual telephone number attributes periodically, it may be desirable to provide the telephone subscriber with an automatic mechanism to specify and effect the telephone subscriber's desired attributes. For the telephony network 300, this can be achieved by providing a remote interface through a touch tone phone or a PC to a database.

In an alternative embodiment, a virtual telephone number is implemented for voice services or for any messaging service over data networks. The differences in implementation are due to the different ways voice calls will be delivered over the data networks. To enable voice over data networks, a directory service can be used to map telephone numbers to data addresses (e.g. IP addresses). The functionality of the present invention may be utilized at this point. However, the equivalent of a telephony switch may be implemented at any number of points in the data network including the telephone subscriber's (virtual telephone number service subscriber) “phone”. In that case, the treatment of the call will be done at any point in the network that is logically equivalent to the telephony switch's call treatment capability.

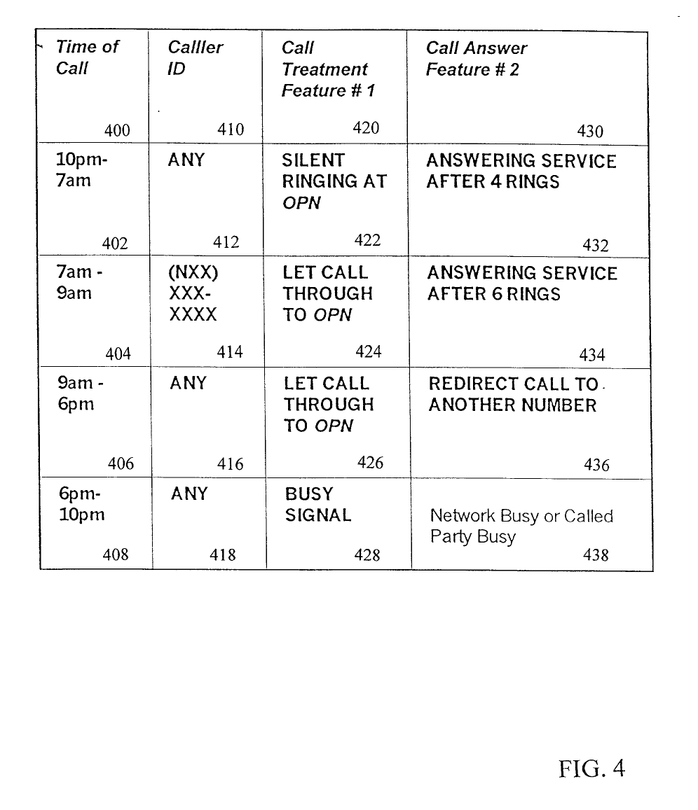

Referring next to FIG. 4, shown is a diagram depicting an example of an attribute table for a single incoming virtual telephone number based on telephone subscriber's specification. The number of fields shown are for purposes of illustration, as there may be more or less options and fields as the situation warrants and technology changes. For example, if the telecommunications service provider allows a variety of rings at the ordinary phone number (OPN), then the type of ring can also be specified by the telephone subscriber.

Specifically, depicted is an attribute table wherein depending on the time of the incoming virtual telephone call 400, 402, 404, 406 and 408 and the incoming telephone call number restrictions 410, 412, 414, 416 and 418 the telephone call may either ring through to the ordinary telephone number 424 and 426, route through silently to the ordinary telephone number 422 or receive a busy signal 428. Subsequently the incoming virtual telephone number may receive a series of different types of treatment at the ordinary telephone line of the telephone subscriber 430, 432, 434, 436 and 438. The examples, as provided, include routing the incoming virtual telephone call to an answering service after four 432 or six rings 434, redirecting the incoming virtual telephone call to another telephone number 436 or forwarding a busy signal 438.

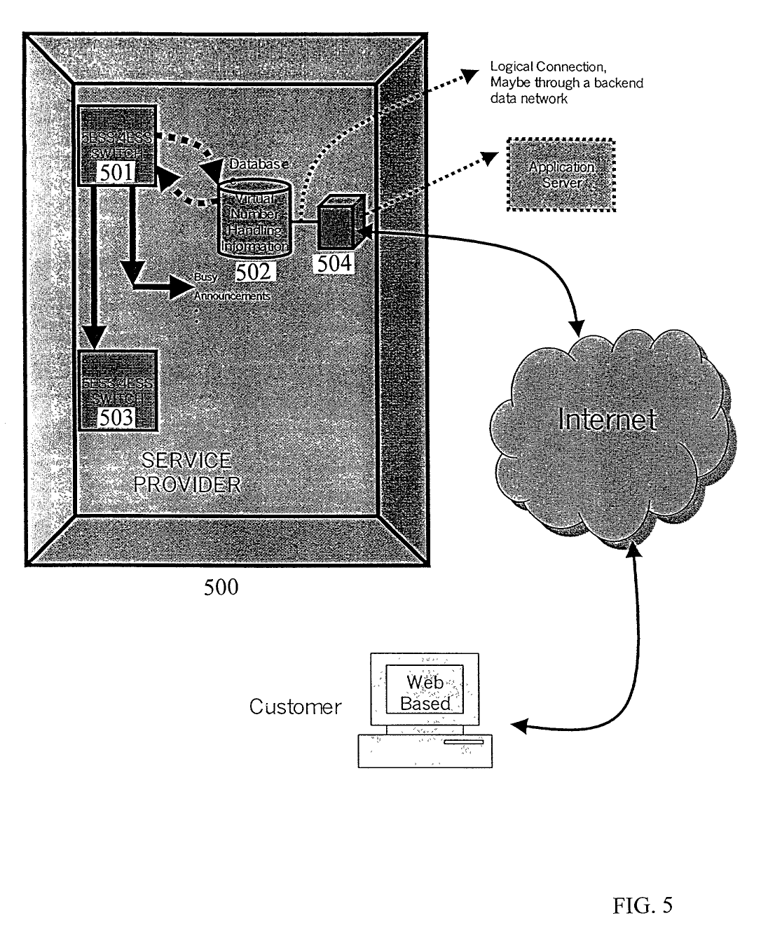

Referring next to FIG. 5, shown is an alternative embodiment of the virtual telephone number service disclosed herein. An incoming virtual number telephone call is initiated by a caller. The incoming virtual number telephone call then is routed to the service provider for processing 500. The call handling apparatus first transfers the incoming virtual number telephone call to a first processing switch 501. The first processing switch 501 then analyzes the telephone call characteristics. Herein the incoming virtual number telephone call is examined and circulated through the virtual number handling information database 503 to determine if the telephone subscriber desires to receive the incoming virtual number telephone call. In addition, in this embodiment the incoming virtual telephone call is further routed through an offsite database, a back-end database or an Internet database 504 which may be linked to an offsite computer network. Furthermore, the offsite computer network may be linked to the telephone subscriber's computer through a web-based system allowing the caller to further modify the attributes and restrictions associated with the incoming virtual number telephone call. Alternatively, the incoming telephone call can be sent to an off-site PBX or other voice-over IP or telephony network. Thereafter the call is re-directed to the virtual number handling information database 502 for further processing. If the incoming virtual number telephone call does not meet the specific criteria which was preset by the telephone subscriber the call is routed to various points of termination (i.e. busy signal, announcement, answering system or service). However, if the incoming virtual number telephone call does meet the specific criteria the incoming virtual number telephone call will travel to several points of transfer. For example, the incoming virtual number telephone call may ring through, be redirected, or alternated. Alternatively, the incoming virtual number telephone call may travel to a second processing switch 503 wherein the incoming virtual number telephone may be sent to the telephone subscriber's ordinary telephone line to be received by the telephone subscriber. Furthermore,

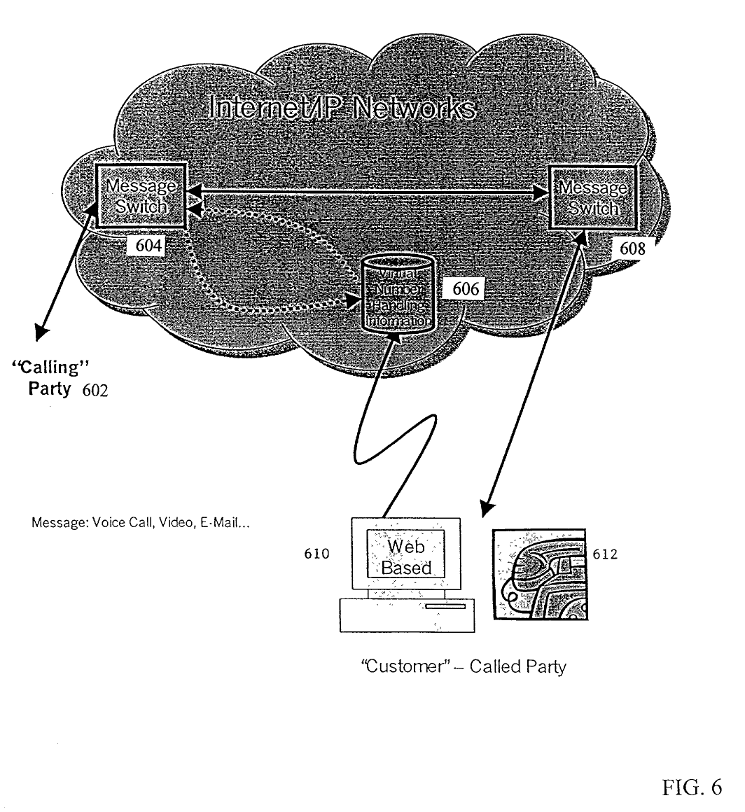

Referring to FIG. 6 depicted is an alternative embodiment of the disclosed invention. In this embodiment, a virtual number telephone service is provided wherein the entire system is processed through an Internet/IP network to handle Internet-based calls in the same manner as disclosed herein. In another alternative embodiment, the entire virtual telephone number service as disclosed may be handled within the telephone subscriber's own home and telephone line without the interaction of a telephone network service provider. In this embodiment, a calling party 602 initiates a telephone call which is routed to a message switch 604. At the message switch 604 the virtual number handling information 606 is interpreted via a web-based database 610 and the call is properly routed to a second message switch 608 which routes the call to the called party 612. In this embodiment, several types of calls may be handled, including but limited to common-carrier incoming telephone calls, long-distance telephone calls, video calls, e-mail based calls, or alternative versions of voice calls.

While the present invention has been described with reference to the preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

I claim:

1. A telecommunication system and apparatus for prioritizing and enhancing privacy of incoming telephone calls comprising:
a plurality of interconnected central office switching systems which provide a plurality of virtual telephone numbers linked to a single ordinary telephone line and number, wherein each of said central office switching systems connects to a plurality of local communication lines for routing an incoming telephone call to said subscriber;
a database for storing call attributes for processing incoming calls; and
a service management system connected to said database for storing call attributes;
wherein in response to an incoming call said service management system routes incoming calls associated with said virtual telephone numbers and ordinary telephone numbers in accordance with said call attributes.

2. A telecommunication system and apparatus as defined in claim 1 wherein said database has associated therewith user-selected call attributes.

3. A telecommunication system and apparatus as defined in claim 1 wherein said database has associated therewith specific default call attributes which can be enabled in lieu of user-selected call attributes.

4. A telecommunication system and apparatus as defined in claim 1 wherein said call attributes comprises a time of day restriction.

5. A telecommunication system and apparatus as defined in claim 1 wherein said call attributes comprises a call-type restriction.

6. A telecommunication system and apparatus as defined in claim 1 wherein said call attributes comprises an area-code restriction.

7. A telecommunication system and apparatus as defined in claim 1 wherein said call attributes comprises an exchange prefix restriction.

8. A telecommunication system and apparatus as defined in claim 1 wherein said call attributes comprises a DNIS restriction.

9. A telecommunication system and apparatus as defined in claim 1 wherein said call attributes comprises a ANI restriction.

10. A telecommunication system and apparatus as defined in claim 2 wherein said user-selected call attributes c an be programmed via a user's touch-tone key pad.

11. A telecommunication system and apparatus as defined in claim 2 wherein said user-selected call attributes can be programmed via a user voice prompt.

12. A telecommunication system and apparatus as defined in claim 2 wherein said user-selected call attributes can be programmed via an electronic call-handling apparatus.

13. A telecommunication system and apparatus as defined in claim 1 wherein said service management system connected to said database is located at a central office.

14. A telecommunication system and apparatus as defined in claim 1 wherein said service management system connected to said database is located at the location of an end-user.

15. A telecommunication system and apparatus as defined in claim 1 wherein said service management system comprises an Internet/IP based network.

16. A method of enhancing privacy of incoming telephone calls comprising the steps of:
linking a plurality of virtual telephone numbers to an ordinary telephone number and telephone line;
assigning and storing call attributes for processing said incoming telephone calls on a call attribute database;
receiving said incoming telephone call;
correlating the characteristics of said incoming telephone call with pre-determined call attribute restrictions stored on said call attribute database;
routing said incoming telephone call in accordance with said call attributes.

17. A method as recited in claim 16 wherein said call attributes may be updated by said user via a user voice prompt.

18. A method as recited in claim 16 wherein said call attributes may be updated by said user via an electronic call-handling apparatus.

19. A method as recited in claim 16 wherein said call attributes may be updated by said user via an electronic call-handling apparatus.

20. A method as recited in claim 16 wherein said call attributes comprises a time of day restriction.

21. A method as recited in claim 16 wherein said call attributes comprises a call-type restriction.

22. A method as recited in claim 16 wherein said call attributes comprises an area-code restriction.

23. A method as recited in claim 16 wherein said call attributes comprises an exchange prefix restriction.

24. A method as recited in claim 16 wherein said call attributes comprises a DNIS restriction.

25. A method as recited in claim 16 wherein said call attributes comprises a ANI restriction.

26. A telecommunication system and apparatus for prioritizing and enhancing privacy of incoming telephone calls comprising:
a communication line comprising an ordinary telephone line and associated ordinary telephone number;
a plurality of virtual numbers associated with said ordinary telephone line;
a database for storing call attributes for processing incoming calls wherein said database comprises a routing means for routing said incoming telephone calls.
